(19) United States
(12) Patent Application Publication
(10) Pub. No.: US 2009/0120377 A1
(43) Pub. Date: May 14, 2009

(54) Fashionable harness garment for pets

(76) Inventor: Deanna Palmer, Spring Valley, CA (US)

Correspondence Address: Deanna Palmer, 10923 Singletree Ln, Spring Valley, CA, 91978, US

(21) Appl. No.: 11/983,968

(22) Filed: Nov. 13, 2007

(51) Int. Cl. A01K 27/00

(52) U.S. Cl. 119/856

(57) ABSTRACT

This invention is a harness garments for pets. The garment preferably consists of 3 main pieces, which are an outer garment, an inside lining and a loop for a hook attachment, which is used to provide for leash is attachment to harness garment. In order to fabricate the device, fabric is cut out for the outer garment using a pattern. The lining for main garment is also cut out using pattern, which may be but does not necessarily have to be the exact same patter used for the fabric. The lining pattern will, however, preferably be of the same general shape, although the size may be smaller around the periphery. The outer garment and lining are connected together to form a body, which has securing mechanism for attaching the device to a pet, as well as embellishments to create a more attractive and aesthetically pleasing harness.

### CROSS REFERENCE TO PREVIOUSLY FILED APPLICATION

This application is entitled priority from a previously filed provisional application. This provisional application was filed on Monday, Jun. 25, 2007. This filing was undoubtedly received by the Patent Office because the self addressed, stamped postcard included in the Express Mail envelope was returned. Unfortunately, the sticker containing the filing number was smeared and is not readable. Furthermore, an official filing notice has not yet been received, so the Serial Number on this Jun. 25, 2007 provisional application is not known to the applicant.

### BACKGROUND OF THE INVENTION

1. Field of the Invention

This invention relates generally to fashionable harness garments for pets.

2. Background

While pet garments are known to exist, there are no known garments that function as a harness that will secure the pet for safety, as required by law in most places, while at the same time providing stylish outerwear. Some known garments use Velcro to attach around neck, but in these garments the pet can quite easily pull out of the Velcro garment, thereby these pets are not secured for their safety, and the pet becomes unleashed, thereby violating the law. No other known devices function as a garment and secure harness in a single unit.

In light of the foregoing, it would be desirable to have a harness dress or garment that eliminates the need for the pet to have two separate items. A garment that functions as both harness and dress would be particularly advantageous given that such a garment would eliminate the need for a harness by itself with a dress worn over it.

### SUMMARY OF THE INVENTION

The present invention advantageously fills the aforementioned deficiencies by providing a fashion harness garment for pets, which functions as both a harness and dress. The invention can be used with the matching leash/lead to function as a harness and still be an attractive garment. Further more the leash/lead may be removed and the harness by itself functions as an attractive garment with out the appearance of a harness.

Generally speaking, the present invention is made up of the following components: (1) fabric or material; (2) thread; (3) D hook; (4) parachute buckle; (5) Velcro, (6) interfacing material or webbing; (7) swivel hooks, and (8) embellishments, such as but not limited to one or more of the following: lace ribbon, bows, appliqueś. The garment is constructed using any fabric or material, but is preferably constructed using washable fabrics made of cotton or cotton blends. However vinyl, suede, leather, plastic or synthetic blends may be used. A Parachute buckle is preferably used to secure the garment around the pet's neck, although it should be further noted that instead of a parachute buckle, a button, hook & eye, bra snaps or any other types of buckles and snaps, including elastic, ties of ribbon, shoestring, rawhide, cording, wire covered with fabric or any other component including a seam or even Velcro may be used to fasten and secure the harness garment around the neck. Velcro is preferably used to secure the garment around the pet's body, although any of the devices mentioned above for securing around the pet's neck could also be used to secure the garment around the pet's body.

A D hook is attached mid-back to allow easy attachment of the coordinating leash/lead. The leash/lead is constructed; preferably using a fabric/material that matches the fabric/material used for the garment, but the leash/lead could be constructed of any material, such as but not limited to washable fabrics made of cotton or cotton blends. However vinyl, suede, leather, plastic or synthetic blends may be used. The leash/lead is interfaced with Pelon interfacing, webbing, plastic, leather, rope, or similar sturdy material to provide strength.

A loop is formed at one end for the hand after the body of the leash/lead has been constructed. Preferably measure about 7 inches down and fold that part down and stitch forming a loop for the hand. This measurement of 7 inches, the length of the leash/lead and size of the loop may very according to personal needs or taste. It may be machine or hand stitched, stapled, glued, Velcro, tied, snapped, buttoned or any other method used to secure fabric or materials together. The swivel hook is attached to the other end, which then is attached to the D hook which is secured to the garment. It may be machine or hand stitched, stapled, glued, Velcro, tied, snapped, buttoned or any other method used to secure fabric or materials together. Further more this invention can also have one or more of the following: Lace, ribbon, bows, or any other type of decoration or embellishment. The embellishments are attached by hand or machine stitching however they may also be secured by fabric glue, Velcro or hot glue gun.

It is an object of the present invention to provide a harness garment for pets that: (1) safely secures pets; (2) comfortably secures pets; provides a fashionable, yet functional, accessory to the pet's wardrobe; and (4) does not suffer from any of the problems or deficiencies associated with the prior art.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 shows the invention from a top view.

FIG. 2 shows the invention in use.

### DETAILED DESCRIPTION OF THE INVENTION

The present invention (sometimes referred to as a harness garment) is directed to be a harness garments for pets. The body 50 of the garment preferably consists of 3 main pieces Piece 1 is garment (sometimes referred to as an outer body). Piece 2 is the lining (lining is preferred but optional) (sometimes referred to as an inner body). Piece 3 is the loop 60 for a hook 70, which is preferably a D hook or wire, or similar device covered fabric and which is further how the leash/lead is attached to harness garment. In order to fabricate the device, fabric is cut out for the garment using a pattern with the body consisting of one piece. The preferred pattern consists of one piece with the neck tabs, tummy tabs & body all as one. It should be noted, however, that the main body 50, which may include optional top stitching 100, could be constructed using any number of constituent pieces that are sewed together or otherwise attached and/or assembled to replicate (or substantially replicate) the form of the invention. For example, rather than have a one piece garment, the garment could be made of two or more pieces that are assembled to resemble and/or approximate a single piece. Similarly, the linking can be made of two or more pieces that are assembled to resemble and/or approximate a single piece. Likewise, the loop 60 for the hook 70 can be made of two or more pieces that are assembled to resemble and/or approximate a single loop.

The pattern could be constructed by cutting the two neck tabs and two body tabs independently and then assembling by machine stitching to form one piece. Assembling via hand stitching is also possible, as well as connecting through the use of snaps or adhesives. The end result would be the same. Lining for main garment is also cut out using pattern, which may be but does not necessarily have to be the exact same pattern used for the fabric. The lining pattern will, however, preferably be of the same general shape, although the size may be smaller around the periphery.

A piece of fabric is also cut for use as the loop 60 for the hook 70, and At should be attached by machine stitching, however hand stitched, stapled, glued, hook and loop fasteners (such as Velcro), tied, snapped, button, riveting or any other method that would permanently and securely attach to loop to the harness garment to be used to attach leash/lead. This fabric for the loop 60 is preferably 4 ½ inches by 1 ½ inches, but can be larger or smaller. An acceptable range for the size of the loop 60 would be the width of the hook 70 and any desired length from the neck to the hem. Construction of the loop 60 for the hook 70 proceeds by folding the fabric length wise right sides together, with a seam being stitched, preferably a ¼ inch seam. Turn and press flat, then thread the hook 70 thru loop piece. The preferred method is to fold loop 60 in half stitch raw edges together with hook 70 threaded in between. Place completed loop 60 on the outer side of the harness garment, preferably to the right side center of garment neck edge. Stitch the loop 60 to the garment, and with right sides together pin the lining to the garment and stitch, preferably leaving an opening large enough for turning. Turn garment to the right side out press, slip stitch or machine stitch the opening dose. On the out side top stitch the loop 60 to the body 50 of the harness garment, with the hook 70 being positioned on the loop 60 between the neck edge and the bottom of garment preferable in the center. However one long loop 60 from neck to hem with hook 70 sliding on the loop 60 may be used. Then the loop 60 would be attached at neck or hem. Reinforcement is optional, but preferred.

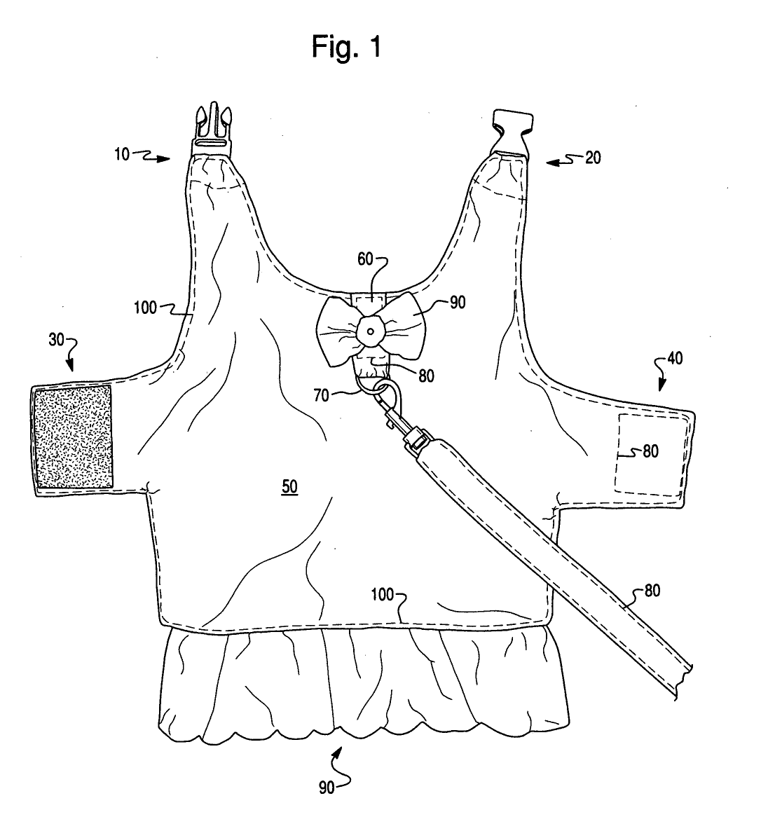

The harness garment preferably has four extension tabs, although the number of extension tabs can be increased. If additional extension tabs are used it would be preferable to have them added in pairs because the extension tabs provide means for securing the harness garment while in use. The aforementioned four tabs are shown best in FIG. 1, and are a male neck tab 10, a female neck receptacle 20, a body extension with fastener 30 and a body extension with reciprocal fastener 40. It should be clear to those of skill in the art that it is within the scope of this disclosure to have the securing/fastening mechanisms switched from what is shown in FIG. 1, specifically switching securing/fastening mechanisms from right to left or right to left.

The male neck tab 10 is secured to the body 50 by threading the extension thru the open end of the buckle. It should be firmly and permanently attached by machine stitching, riveting, stapling or any other method that secures materials together. Repeat the procedure for the female neck receptacle 20. The male neck tab and female neck receptacle are preferably respective ends of a parachute buckle. Instead of using a parachute buckle, however, any number of other devises may be used. Specifically, instead of a parachute buckle, a button, hook & eye, bra snaps or any other types of buckles and snaps, including elastic, ties of ribbon, shoestring, rawhide or cording or any other component including a seam may be used to fasten and secure the harness garment around the neck. While this embodiment describes the use of a single male neck tab and a single, corresponding female neck receptacle, it is certainly possible and indeed within the scope of the invention to use multiple male neck tabs and a corresponding number of female neck tabs. In fact, the use of a pair of male tabs and female receptacles is preferred.

The body extension with fastener 30 and the body extension with reciprocal fastener 40 extend under the animal's body to secure the harness garment around the pet. Hook and loop fasteners, such as those commonly known by the trademark VELCRO, provide the preferred method of connection (shown in FIG. 1), however button, snap, parachute buckle or ties or any method that encloses can be utilized to secure the harness garment around the body of the animal.

The harness garment may also be decorated with various optional trim elements 90. Specifically, these trim elements 90 can include one or more embellishments, ribbons, bows, beads, appliques and lace, all of which provide a very nice finishing touch. It should also be noted that for fashion purposes and variety a skirt of any type such as gathered, pleated, etc. maybe added to the harness garment. In addition a collar of any style and or sleeves maybe added for personal taste.

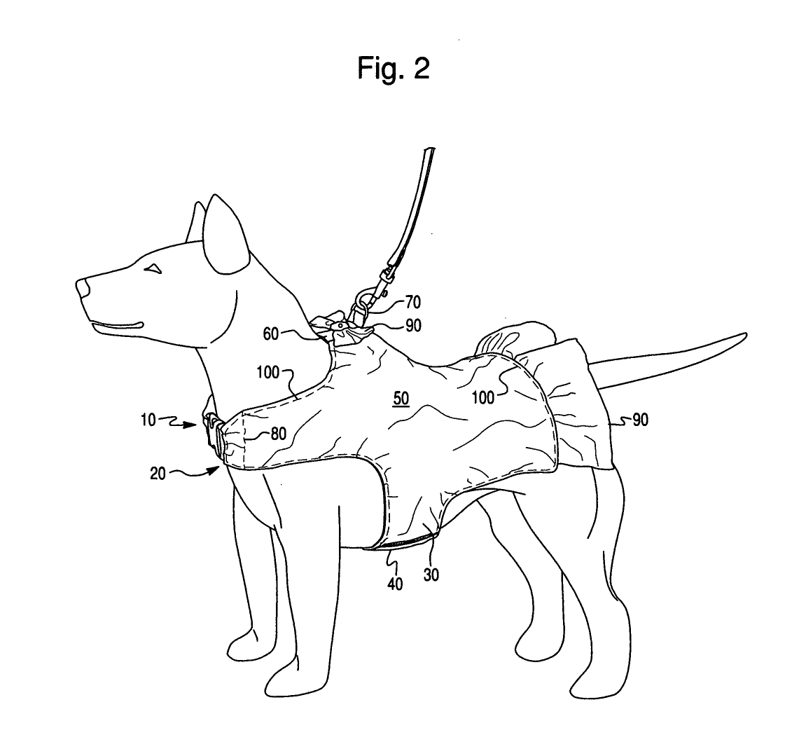

FIG. 2 shows the harness garment being worn. To operate the harness garment, place the body 50 of the garment on the animal so that the loop 60 and hook 70 are on the outside. Take the male neck tab 10 around and in front of the neck/chest of the animal and insert it into the female neck receptacle 20. Take the body extension with fastener 30 around the under-side of the animal and secure it to the body extension with reciprocal fastener.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. An fashionable harness garment for pets comprising:
a body having an inner portion, an outer portion, a neck edge and a posterior edge opposite the neck edge, wherein the body is shaped to have a first neck portion having a male neck tab secured thereto, a second neck portion having a female neck receptacle secured thereto, a first body extension having a fastener and a second body extension having a reciprocal fastener;
a piece of fabric having a perimeter;
a hook; and
wherein the outer body portion is connected to the inner body portion
wherein the piece of fabric is passed through the hook and folded to create a loop, with the loop being connected to the outer portion of the body substantially at the neck edge.

2. The garment of claim 1 wherein the hook is a D-hook.

3. The garment of claim 2 wherein the outer body portion is made of a material selected from the group consisting cotton, vinyl, suede, leather, plastic and synthetic blended material.

4. The garment of claim 3 wherein the male neck tab is a male end of a parachute buckle and the female neck receptacle is a female end of a parachute buckle.

5. The garment of claim 4 wherein the fastener of the first body extension and the reciprocal fastener of the second body extension are matching hook and loop fasteners.

6. The garment of claim 5 wherein the piece of fabric is 4.5 inches by 1.5 inches.

7. The garment of claim 6 wherein the fabric is folded lengthwise with the perimeter then being stitched with a seam.

8. The garment of claim 7 wherein the seam is a 0.25 inch seam.

9. The garment of claim 8 further comprising at least one trim element connected to the outer body.

10. The garment of claim 9 wherein the at least one trim element is a skirt connected to the posterior edge.
